(19) United States
(12) Patent Application Publication
(10) Pub. No.: US 2006/0246184 A1
(43) Pub. Date: Nov. 2, 2006

(54) Package

(76) Inventors: Peter Wilhelmus Henricus Rietjens, Magnoliastraat (NL); Matthias Giebel, Wardenburg (DE)

Correspondence Address: PERMAN & GREEN, 425 POST ROAD, FAIRFIELD, CT, 06824, US

(21) Appl. No.: 10/563,442

(22) PCT Filed: Jul. 5, 2004
(86) PCT No.: PCT/EP04/07320

§ 371 Date: Jun. 2, 2006

(30) Foreign Application Priority Data
Jul. 4, 2003 (EP) 03015182.3

(51) Int. Cl. A23B 7/148

(52) U.S. Cl. 426/106

(57) ABSTRACT

The package according to the invention is mainly made from transparent or partially transparent or intransparent, especially multilayer films (seal layer/barrier layer). The package, i.e. the film, includes an opening area in which a tape is provided, preferably sealed, on the inside or the outside, preferably the outside of the film. The tape 4 together with the film are repeatedly foldable in order to open and close the package and whereas the tape 4, once folded, prevents the plastic film from being unfolded. The tape can be reversibly folded in multiple forms.

The present invention relates to a package comprising a plastic film (10) with at least two seals and an opening area, the package comprising a plastically deformable tape in the opening area, whereas the tape is applied on, preferably sealed to the film, in the opening area and inside or outside the package item.

Packages of are nowadays often used to sell foodstuff. Since in most cases the contents of the package it not used at once after the initial opening, it is preferable to that the bags are reclosable.

The object of the present invention is to provide a reclosable package.

The objective is solved with a package according to the independent claim 1. Preferred embodiment of the inventive package are claimed in the dependant claims 2-8.

According to the present invention, the package comprises a plastically deformable tape. This tape is preferably a film and can be made of plastic and/or metal, preferably aluminium or an alloy based on aluminium. Especially if a metal tape is used, it is preferably covered with a plastic material, especially a film, that is preferably sealable. The tape is applied on, preferably sealed on the wrapping. The tape can be applied to the film prior, during or after the forming of the package.

The tape is arranged in the opening area, preferably below the seal in the vicinity of the opening area. This embodiment of the present invention has the advantage, that the package can be opened by ripping of the seal in the opening area. The tape can be applied between two layers of film of the wrapping or outside of the wrapping. The first embodiment has the advantage that the tape cannot be accidentally ripped of.

The packaging according to the invention is mainly made from transparent or partially transparent, partially opaque and/or coloured plastic films. These films are preferably multilayer films with at least one sealing layer and/or one barrier layer. The sealing layer allows to seal parts of film together for example by applying heat and/or pressure. The barrier layer reduces the migration of gaseous substances through the film, for example oxygen into the packaging and water vapour from the packaging. The plastic film according to the invention can be provided as a wrapping and can be produced on wrappingpers, especially horizontal wrappingpers.

The package comprises an opening area in which a tape is provided, preferably sealed, on the inside or the outside, preferably the outside of the film. In the opening area the films or at least one film is folded in order to reclose the package are the initial opening. The tape is folded together with the film(s) in order to open and close the package and whereas the tape, once folded, prevents the plastic film from being unfolded. This embodiment of the present invention allows to reclose the package with a very narrow tape. The package can be opened and closed unlimitedly. The tape together with film(s) can are be reversibly folded in multiple forms.

Preferably, the package comprises, except the wrapping, a tray carrying the goods, especially slices of food, e.g. slices of cheese, ham etc. The tray functions also as a mechanical stabiliser of the packaging so that the packaging maintains its shape, which improves the esthetical aspects of the packaging. More preferably, the tray and/or the wrapping have means to limit the extent of removal of the tray from the wrapping.

The invention will be explained in more detail below with reference to the appended drawings 1-3, in which:

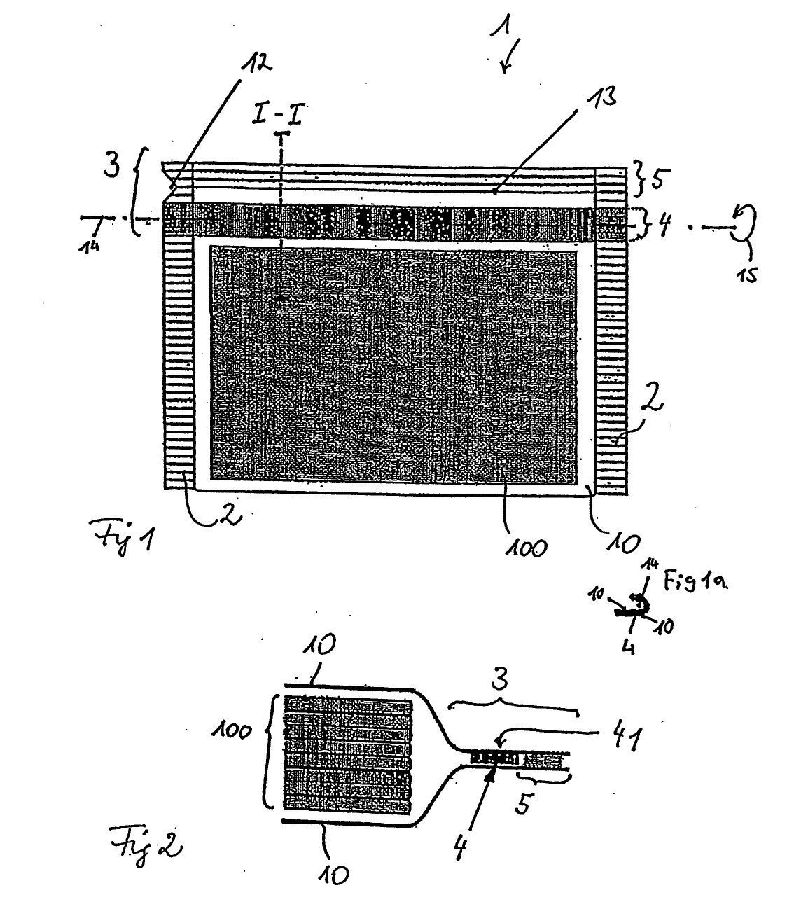

FIG. 1 shows the closed inventive package

FIG. 1a shows the folded metal tape

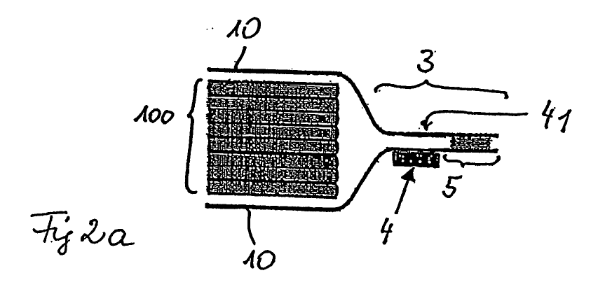

FIG. 2 shows an enlarged cross sectional view of one embodiment the opening area

FIG. 2a shows an enlarged cross sectional view of another embodiment the opening area

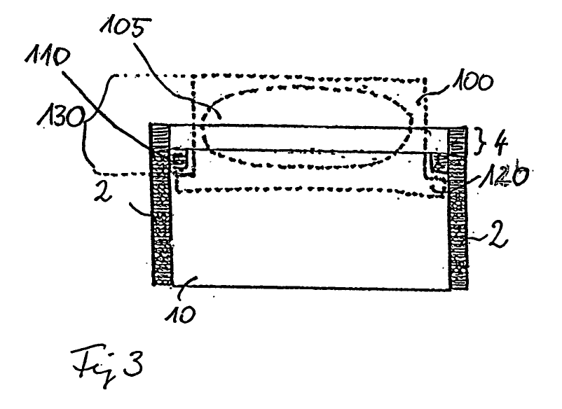

FIG. 3 shows the package with a tray

FIG. 4 shows the inventive package with a removed tray

In FIG. 1, an embodiment of a package 1 according to the invention is schematically shown. The package 1 is made from a plastic film 10 on a flowwrapper-machine and comprises three seals 2, 5. The film 10 encloses preferably a tray 100 carrying packaged goods. Additionally, the package comprises an opening are 3, which is sealed with seal 5. The person skilled in the art understands that the seal can be also opposite of the opening area. The opening area comprises a metal tape 4, sealed to film 10, which is made of a plastically deformable material which is shapeable in a unlimited number of shapes, preferably in a first position or configuration in which the package is closed and a second position in which the package is opened. The tape remains in the repective shape until it is remodelled. In one of the positions the tape is folded. This characteristic allows the use of the tape 4 as a closure means in connection with the package 1. Between the seal 5 and the metal tape 4 easy opening means are provided preferably in form of an indentation 12 and preferably of a scoring 13. The package can be opened by tearing of seal 5 beginning at the indentation 12 along the scoring 13. After the package is opened, the packaged goods can be partially removed and the package can be reclosed, by folding the upper part of opening area around axis 14 as depicted by arrow 15. During the folding, the closing means are also folded and remain in the folded state until they are manually unfolded again.

In FIG. 1a, the folded metal tape 4 is schematically shown. The tape 4 is bended together with the film on its both sides. The entire structure is bended around axis 14. The bending of the films together with the tape allows the use a relatively small tape. This is much more advantageous than only bending the tape over the opening of the package.

FIG. 2 shows an enlarged cross-sectional view of the opening area 3 and a part of the residual package 1 in its initially closed state following the section line I-I in FIG. 1. In the opening area 3, the opening means 5 are provided e.g. as an easy to open strip of the film 10 which is removed from the package 1 when the package 1 is initially opened by a user. The tape 4 is sealed on the inside of film 10. To reclose the package 1, the tape 4 is folded, preferably along approximately a complete width of the package 1. For this purpose a user folds the tape 4 preferentially by applying a kink to the tape 4, preferentially at a location near the centre of the tape 4 which is indicated by reference sign 14.

In FIG. 2a the opening area according to FIG. 2 is shown, but with the tape 4 sealed on the outside.

Preferentially, the tape 4 is provided as a metal, especially aluminium, or as a metal alloy, especially aluminium alloy or as a plastic material. Furthermore, the tape 4 is provided as a laminate, especially a laminate comprising aluminium or aluminium alloy.

In FIG. 3, an advantageous embodiment of the invention is shown, where the initially opened (or re-opened) package 1 with the film 10, the seam 2 and the tray 100 is provided such that the tray 100 is provided slidable inwards and outwards only until a certain extent. In the advantageous embodiment of FIG. 3, there are provided means to prevent the tray 100 together with the packaged goods 105 of being completely pulled-out of the package 1, i.e. pulled-out of the flowwrap 10. To this end, there is, for example, provided a second special seam portion 110 near the opening of the opened package 1. The second special seam portion 110 interacts with special end portions 120 of the tray 100 to prevent a complete pulling-out of the tray 100 from the package 1 by allowing a user to open the package 1 only over a part of the broadness of the package 1. Preferentially, the special end portions 120 of the tray 100 are provided as regions of the tray 100 having superior broadness than other parts 130 of the tray 100. On the one hand, the second special seam portions 110 of the package 1 are provided so as to allow the other parts 130 of the tray 100 to slide inside and outside the package 1, carrying the goods 105 with them. On the other hand, the second special seam portions 110 of the package 1 are provided so as to prevent a passing of the special end portions 120 of the tray 100 to slide outside the package 1. By the interaction of these means, the tray 100 is prevented from being completely unbaged. Therefore, the tray 100 can only partially be unbaged, i.e. up to a predetermined maximum extent of, e.g. 80% or 90% or 95%, depending especially to the mechanical strength of the special end portions 120 of the tray 100 and a usual force applied by the user of the package 1 to pull out the tray 100 from the package 1.

The form of the package 1 is depicted in the figures as being rectangular. However, this is a mere example of possible forms of the package 1, which can be provided—especially adapted to the form of the (slices of) goods 105—round, oval or the like, as well.

1. Package (1) comprising a plastic film (10) with at least two seals (2) and an opening area (3), the package (1) comprising a plastically deformable tape (4), the tape (4) being applied on, preferably sealed to the film, in the opening area (3) and inside or outside the package item, the package (1) further comprising a tray (100), characterized in that said package (1) and said tray (100) comprise means (110, 120) to partially remove said tray (100) from said package (1) only up to a predetermined maximum extent.

2. Package item according to claim 1, characterized in, that said tape (4) and said plastic film (10) are provided repeatedly foldable in order to reclose the package (1) whereas the tape (4), once folded, prevents the plastic film (10) from unfolding.

3. Package (1) according to claim 1, characterized in that said tape (4) comprises a metal or a metal alloy.

4. Package (1) according to claim 1, characterized in that the tape (4) comprises aluminium or an aluminium alloy.

5. Package (1) according to claim 1, characterized in that the tape (4) comprises a laminate.

6. Package (1) according to claim 1, characterized in that the package (1) comprises opening means (5).

7-8. (canceled)

9. Package (1) according to claim 1, characterized in that said tray (100) is provided to carry packaged goods (105).

10. Package (1) according to claim 1, characterized in that said packaged goods (105) are only removed partially up to a predetermined maximum extent.

11. Package (1) according to claim 1, characterized in that said plastic film (10) is provided as a multilayer film (10).

12. Package (1) according to claim 1, characterized in that said packaged goods (105) are cheese and/or ham.
